(19) United States
(12) Patent Application Publication
(10) Pub. No.: US 2015/0230658 A1
(43) Pub. Date: Aug. 20, 2015

(54) ACCELERATED HEATING, COOKING AND DISPENSING INCORPORATING A STORED ENERGY OVEN IN A MOBILE APPARATUS

(71) Applicant: DE LUCA OVEN TECHNOLOGIES, LLC, San Francisco, CA (US)

(72) Inventors: Nicholas P. De Luca, Carmel-by-the-Sea, CA (US); Andrew Perkins, Berkley, CA (US)

(21) Appl. No.: 14/432,992

(22) PCT Filed: May 6, 2013
(86) PCT No.: PCT/US13/39780

§ 371 Date: Apr. 1, 2015

Related U.S. Application Data
(60) Provisional application No. 61/642,864, filed on May 4, 2012.
(60) Provisional application No. 61/708,602, filed on Oct. 1, 2012.

(51) Int. Cl. A47J 37/04; A47J 27/62

(52) U.S. Cl. CPC A47J 37/045; A47J 27/62

(57) ABSTRACT

A system including a conveyance system and a stored energy cooking oven. The mobile system for heating a product including: an oven including wire mesh heating elements arranged in a parallel circuit and configured to reach 1400 Kelvin in less than about 30 seconds, wherein the heating elements are shaped to include a surface radiating heat; a stored energy device configured to provide direct current to energize the heating elements; and a conveyer configured to convey the product to a heating position facing the surface radiating heat, wherein a distance of an outer surface of the product is less than six inches from the surface radiating heat.

### CROSS REFERENCE TO RELATED APPLICATION

This application claims priority from and the benefit under 35 U.S.C. §119(a) of U.S. Provisional Application No. 61/642,864, filed May 4, 2012 and U.S. Provisional Application No. 61/708,602, filed Oct. 1, 2012, and the entire disclosures of which are hereby incorporated by reference for all purposes as if fully set forth herein.

Further aspects of the mobile apparatus may be found in U.S. Pat. Nos. 8,126,319, and 8,145,548, and U.S. application Ser. Nos. 13/284,426, 12/345,939, 13/405,975, 13/430,189, the contents of which are incorporated herein, in their entirety.

### FIELD

The following invention relates to a stored energy oven including wire mesh heating elements. The oven can be used in conjunction with a storage system for foods in the context of a vending system.

### BACKGROUND

In considering the combination of a stored energy oven incorporating batteries, several difficulties arise. The weight of the batteries requires that their placement does not impact the stability of the machine. However, the positioning of the batteries may not be ideal with respect to the positioning of the oven or storage containers. The separation of the oven from the stored energy source necessitates appropriate sizing and positioning of the high current elements. 3) Supporting a plurality of stored energy ovens in a transportable chassis can be difficult.

In view of the problems described above, automated food storage, heating and dispensation systems are needed to address the deficiencies of transferable ovens.

### SUMMARY

The present teachings provide embodiments of automated product storage, heating and dispensation system and methods, and features thereof, which offer various benefits. The system can employ multiple and integrated activation, enabling, and disabling of safety mechanisms, systems, operations, and the like to promote safe, efficient, and effective use of the devices and methods disclosed herein.

In some embodiments, a high power stored energy oven can be coupled to a food storage container and an electronic control system to allow for control of the oven based on the food placed within the oven. The food storage container can be outfitted with a refrigeration unit to allow for chilling or freezing of foods and a sensor system to detect the placement or removal of a food or packaged food.

The electronic control system communicating between the storage container and the oven can allow for monitoring of the items removed from the container and sensing of the items to be cooked at the oven. Sensing technologies, such as, infrared, bar codes, vision cameras, radio frequency tags, bar codes, and the like can be used with the container or oven to determine the item removed from either or placed within either. In some embodiments, the resistance of the multiple wire mesh elements can be reduced by placing them in a parallel electrical circuit. The oven cooking parameters can include running voltage, cycle times, cycle profile, rack spacing, fan speeds, and the like.

In some embodiments, an invoicing and billing component can be provided. The invoicing and billing component can allow for the incorporation of a user identification system by employing a coded id card fitted with a radio frequency chip, a magnetic strip, a bar code and the like, and further synchronizing the system to a web portal through the Internet. The billing system can allow a service provider of the vending system to charge a customer for the food, the use of oven, or both.

According to various embodiments, a mobile system for heating a product is disclosed. The mobile system including: an oven including heating elements and configured to reach 1400 Kelvin in less than about 30 seconds, wherein the heating elements are shaped to include a surface radiating heat; a stored energy device configured to provide direct current to energize the heating elements; a conveyer configured to convey the product to a heating position facing the surface radiating heat; and a chassis wherein the oven, the stored energy device and the conveyer are disposed.

According to various embodiments, a process of vending foods is disclosed. The process including: placing an item within a storage container; dispensing with automation the item within close proximity to or within a cooking oven including heating elements that reach 1400 Kelvin in less than about 30 seconds, wherein the heating elements are shaped to include a surface radiating heat; heating the product within the cooking oven; and conveying the cooked the one or more food items from the cooking oven.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a food vending process incorporating a stored energy oven, according to exemplary embodiments.

FIGS. 2a, 2b, 2c and 2d are schematic diagrams of a transportable vending system, according to exemplary embodiments.

FIG. 3 illustrates a food storage container, according to exemplary embodiments.

FIGS. 4a and 4b are schematic diagrams of a portion of a transportable heating system, according to exemplary embodiments.

FIG. 5 is a schematic diagram of food item conveyer, according to exemplary embodiments.

FIG. 6a is a schematic diagram of an upper housing of a stored energy oven, according to exemplary embodiments.

FIG. 6b is a schematic diagram of a lower housing of a stored energy oven, according to exemplary embodiments.

FIG. 6c is a schematic diagram of a stored energy oven, according to exemplary embodiments.

FIG. 7 is a schematic of a plate dispensing system, according to exemplary embodiments.

FIG. 8 is a schematic of a portion of a conveyor, according to exemplary embodiments.

FIG. 9 illustrates table of energies consumed by a stored energy during a cooking cycle, according to exemplary embodiments.

FIG. 10 is a process flow diagram for dispensing a food item.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION OF PREFERRED EMBODIMENT(S)

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

Additional features of the invention will be set forth in the description which follows, and in part will be apparent from the description, or may be learned by practice of the invention.

In some embodiments, the present teachings are directed to vending systems and methods, and features thereof, which offer various benefits. The systems and methods can employ multiple and integrated activation, enabling, and disabling safety mechanisms, systems, and steps that promote safe, efficient, quick, and effective use of the systems and methods.

In some embodiments, the current teachings provide a system incorporating a stored energy oven that overcomes the obstacles of traditional machines, such as, vending machines. Automated food storage, cooking and dispensation systems are needed to address the deficiencies of conventional vending systems for hot foods cooked to order.

1) The system allows for the greatest flexibility with regard to the various types of objects that can be heated in the oven. The system allows for foods that can be stored in a storage container and cooked in the oven.

2) The system allows for automated placement of an object, such as, a food item, within the stored energy oven to insure safe operation of the system. In some embodiments, the system can be unattended.

3) The system can automatically adjust the oven settings with respect to the object placed within it.

4) Various objects, such as, food items, may be stored and easily swapped from the unit without requiring modifications to any of the mechanical or electrical systems.

5) The system can allow for ease of invoicing and the ability to charge a customer for a service, for example, a food item and a cooking process of the same.

6) The system can be as small enough to be transferable in, for example, a food vending truck.

A mobile apparatus capable of heating/cooking various items in accelerated times is described. In some embodiments, the mobile apparatus can be a truck, van, bus, car, cart, bin, kiosk, or the like. In some embodiments, the mobile apparatus can include stored energy devices capable of providing power directly to heating elements. In some embodiments, the heating elements can include wire, forming a mesh. In some embodiments, a mesh including wire elements includes uninsulated wire. In some embodiments, the heating element can includes a metal or metal alloy sheet with perforations, forming a mesh, webbing or screen. In some embodiments, the heating elements can be arranged in a parallel circuit. In some embodiments, the wire includes nichrome. In some embodiments, the power provided directly to the heating element can be via direct current. In some embodiments, the heating elements are exposed to air.

The term “mobile” refers to the movability of the apparatus. An apparatus of the present teachings includes a mobility device, such as, wheels, coasters, or similar options which allow the apparatus to be easily moved. Wheels allow movement by the rotational movement of the wheels on axels within a truck, for example. In some embodiments, treats or pads, which reduce the co-efficient of frictions, may be used in a specialized kiosk or cart. As such, the apparatus is constructed such that constant movement is intended and as constant movement can increase the wear and tear on apparatus. The wear and tear can decrease the life or mean-time-between-failure the apparatus, when such apparatus is not intended to be easily moved, or often moved. Movability may include the change of physical location, from one town to a second town via a truck or the like, or from a storage facility or closet to a location of operation, such as, a kiosk in a mall.

In some embodiments, the mobile apparatus can include a vending machine capable of dispensing fully cooked edible products in less than about 5 minutes. In some embodiments, the apparatus can include a vending machine capable of dispensing fully cooked edible products in less than about 3 minutes, in less than 1 about minute.

In some embodiments, the mobile apparatus can cook and dispense fully cooked edible products in less than about 5 minutes, when the edible product is initially frozen and stored within the mobile apparatus. In some embodiments, the mobile apparatus can cook and dispense fully cooked edible products in less than about 3 minutes, when the edible product is initially frozen and stored within the mobile apparatus. In some embodiments, the mobile apparatus can cook and dispense fully cooked edible products in less than about 1 minute, when the edible product is initially frozen and stored within the mobile apparatus. In some embodiments, the mobile apparatus can cook and dispense fully cooked edible products in less than about 30 seconds, when the edible product is initially frozen and stored within the mobile apparatus.

In some embodiments, the edible product is a pizza, sandwich (Panini), bread bowl and soup, fried chicken, hamburgers, hot dogs, etc. In some embodiments, the edible product is dispensed fully cooked in a single step. In some embodiments, the edible product is dispensed fully cooked in multiple (2, 3, 4, or more) steps.

The food cooked in the accelerated manner generally prior to cooking has a uniform thickness of less than about one inch, less than ¾ of an inch, less than about ½ of an inch, less than ¼ of an inch. The cooked food can be browned on an outer surface, while the interior of the food is heated to about 100 degree Fahrenheit or greater, about 120 degree Fahrenheit or greater, about 140 degree Fahrenheit or greater, about 150 degree Fahrenheit or greater, or the like.

In some embodiments, a cadaver can be incinerated in the oven. The cadaver can be of an animal or a human. When a cadaver or another object brought by a consumer to be heated or incinerated to the mobile apparatus, the input end of the oven can point to an exterior of the mobile apparatus. In some embodiments, the output end of the oven can point to an inside of the mobile apparatus, for example, to collect ashes. In some embodiments, the output end and the input end of the oven can point to an exterior of the mobile apparatus.

In some embodiments, the object is accepted at the input end by a conveyer. The control system positions the conveyer over the heating elements, and powers the heating elements for a set, determined, or programmed time. In some embodiments, the control system can power the air filtration system when the oven is powered. In some embodiments, the control system can power the air filtration system prior to powering up the oven in order to establish an air flow.

A distance of a surface of a wire mesh heating element from the nearest surface of the object to be heated/cooked/incinerated can be, for example, less than 6 inches, can be less than 4 inches, can be less than 2 inches, can be less than 1 inch, and the like. The distance can be adjusted while the oven is operating. Either the cadaver or the wire mesh heating element can be brought closer to the surface of the cadaver. For example, when wire mesh heating elements are deployed above and below an object to be heating, the bottom wire mesh heating elements can be held at a fixed distance from a conveyor or other mechanized system to convey the object to the heating surface, while the wire mesh heating elements disposed above the object can be lowered or raised as necessary to maintain an optimum distance from the object to be heated.

The mechanized system to convey the object to be heated can include a material able to withstand high temperatures. For example, the mechanized system can include a metal mesh, a chained belt, a fiber glass belt and the like.

In some embodiments, the heating elements of the mobile apparatus are capable of reaching about 1400-1500 Kelvin (K) in less than about 5 minutes. In embodiments, the heating elements of the mobile apparatus are capable of reaching about 1400-1500 K in less than about 3 minutes. In some embodiments, the heating elements of the mobile apparatus are capable of reaching about 1400-1500 K in less than about 2 minutes. In some embodiments, the heating elements of the mobile apparatus are capable of reaching about 1400-1500 K in less than about 1 minute. In some embodiments, the heating elements of the mobile apparatus are capable of reaching about 1400-1500 K in less than about 10 seconds. In some embodiments, the heating elements of the mobile apparatus are capable of reaching about 1400-1500 K in less than about 5 seconds. In some embodiments, the mobile apparatus includes a stored energy device, such as a battery, to directly power the heating element. In some embodiments, the stored energy device includes a charger.

In some embodiments, the vending machine to dispense the edible items is fully automated. In some embodiments, the vending machine to dispense the edible items is partially automated.

In some embodiments, the mobile apparatus further includes a beverage dispenser. In some embodiments, the beverage dispenser dispenses cups, ice, beverages, and/or lids. In some embodiments, the beverage dispenser dispenses hot or cold beverages. In some embodiments, the beverage dispenser dispenses carbonated beverages, water, juices, teas, coffee, smoothies, etc.

A vending system can include a high speed stored energy oven, a food storage container, and a stored energy and switching system. The oven can include top and bottom heater elements, as well as a movable tray.

When using batteries, the stored energy and switching system may be very heavy and thus is most preferably placed at the bottom of the entire vending system 1 to insure that the unit is not top heavy.

In use, food items which may be packaged are placed in storage container upon shelving or trays or bins. The container may be refrigerated, generally at temperatures ranging from −30 to +10 degrees Celsius. A sensor can detect the items or their presence on the trays and communicate to the central processing unit 40.

When desired, a user can scan their identification or payment card via a magnetic swipe. The processor may obtain the cooking information from its own memory system or through access to an off-site database connected through the internet.

Once obtained from storage container, the food may be optionally unwrapped and subsequently placed on for a conveyor for cooking via automation. Identification of the food item on the conveyor may be done via a sensor that can be a bar code scanner able to read a code placed on the packaging of food item. A vision system may also be used to detect the item placed on the conveyer through processor and detector.

With confirmation of the item to be heated has been determined, the oven parameters are changed automatically, including running voltage, cycle times, cycle profile, the spacing between the conveyer and heating elements, and fan speeds. The processor can then signal to a controller and control relays. The power to energize the heating elements can originate from batteries. The timing and pulsation width of the cycle can be controlled by the processor. When cooked or heated, the item is removed from the oven as detected by sensor and the information is transmitted via processor to the associated user account.

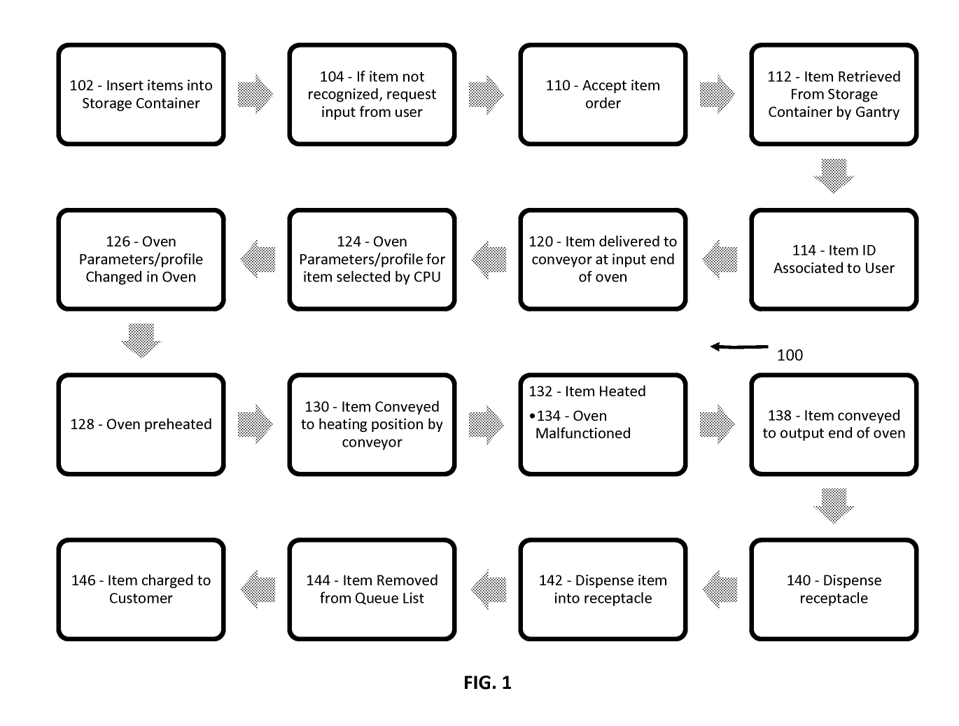

FIG. 1 is a schematic diagram illustrating a vending process incorporating a high speed stored energy oven. The process as described by the flow chart allowing for control of the use of the oven and gives the vendor the option to charge a customer for not only the food but also for a heating cycle associated with running the oven. The process also enables the use of a centralized data system to help associate a customer's buying habits, food preferences, and billing. The system can also be used to a user of oven failures and help to insure the storage container is stocked based on preferences. The dual nature of sensing the items both when removed from the storage container and further when cooked, can give the service provider the option to sell items from container that do not need to be cooked in the high speed oven.

An exemplary process 100 to vend and cook a food product by automation can include operation 102 in which a user/service provider can insert items into a storage container. In operation 104, if the control system determines that the item is not recognized, the control system can request input from user. After operation 202 has been completed, the vending system process can indicate that it is ready for business. When a customer approaches the system, in operation 110, a customer order can be accepted. The order can be input scanning an ID card, receiving input from a user interface, a web interface, and the like. Payment can be accepted at this point. The payment can be for an item or a heating cycle. The system can implement a storage lock option where products or items stored in the storage container cannot be accessed until a payment has been successfully processed. The system, in operation 112, can retrieve an ordered item from a storage container using, for example, a gantry. The system can scan an item ID of the food item placed in queue for cooking. The system, in operation 114, can associate an item ID of the food item to the user. In operation 120, the product to be heated/cooked can be delivered to a conveyor at an input end of the oven. The system can receive a signal from an oven sensor when an item to be cooked is detected. The system can verify that the item is recognized/matched to an Output list. The system, in operation 220, can select oven parameters/profile for item selected to be heated/cooked. The system, in operation 222, can automatically change the oven parameters/profile to match a desired profile. Some profiles can request a preheated oven which can be done by operation 128. After the oven has preheated, the item can be conveyed to the heating position by the conveyor in operation 130. After the item has been heated in operation 132, the item can be conveyed to the output end of the oven in operation 138. An oven malfunction can be detected or determined in operation 134. The system can notify a user that a message to a service technician is advised.

The system, in operation 140, can optionally command a dispensing system to dispense a receptacle. Thereafter, the dispensing system or conveyer can dispense the item into the receptacle. The receptacle can be a suitable container or holder for the heated item, for example, a plate, a bowl, a bag, a bin and the like. The dispensing can be performed by a plate dispensed by a plate handling system. The system, in operation 144, can remove the item from queue list. The system, in operation 146 can charge a customer.

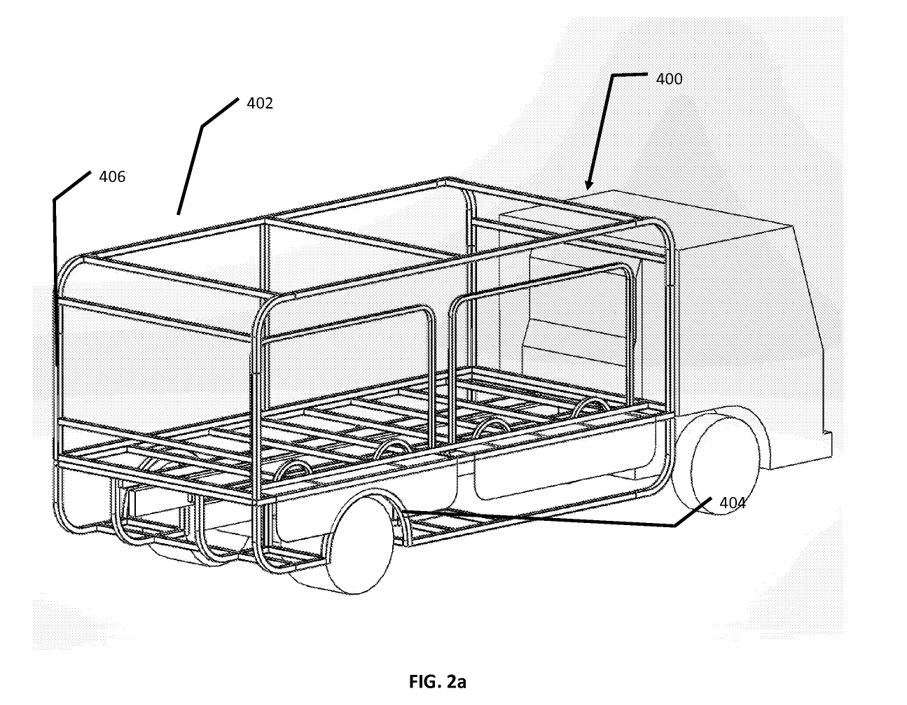

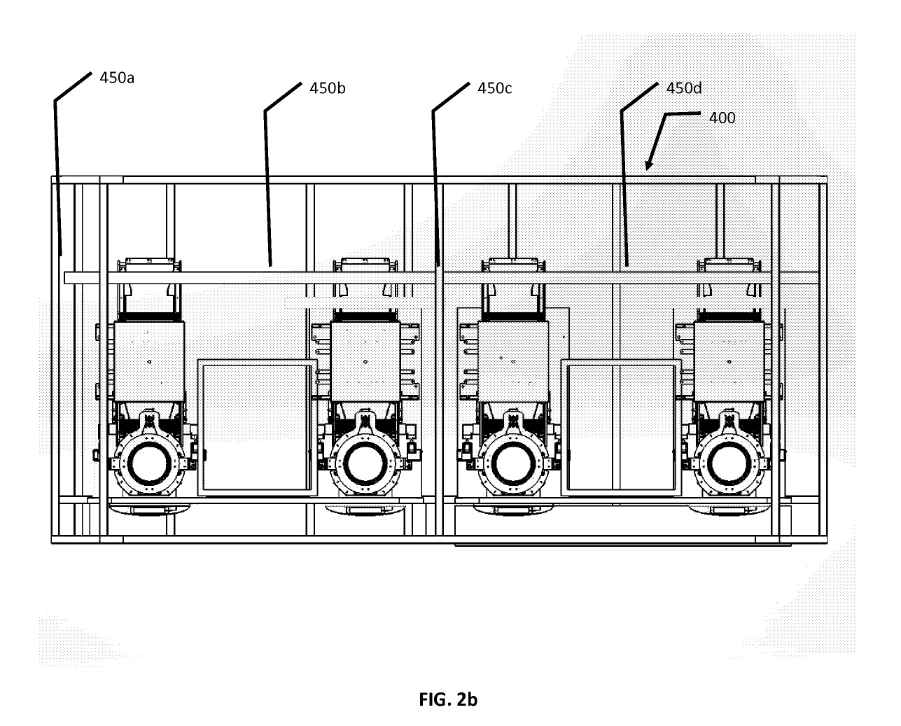

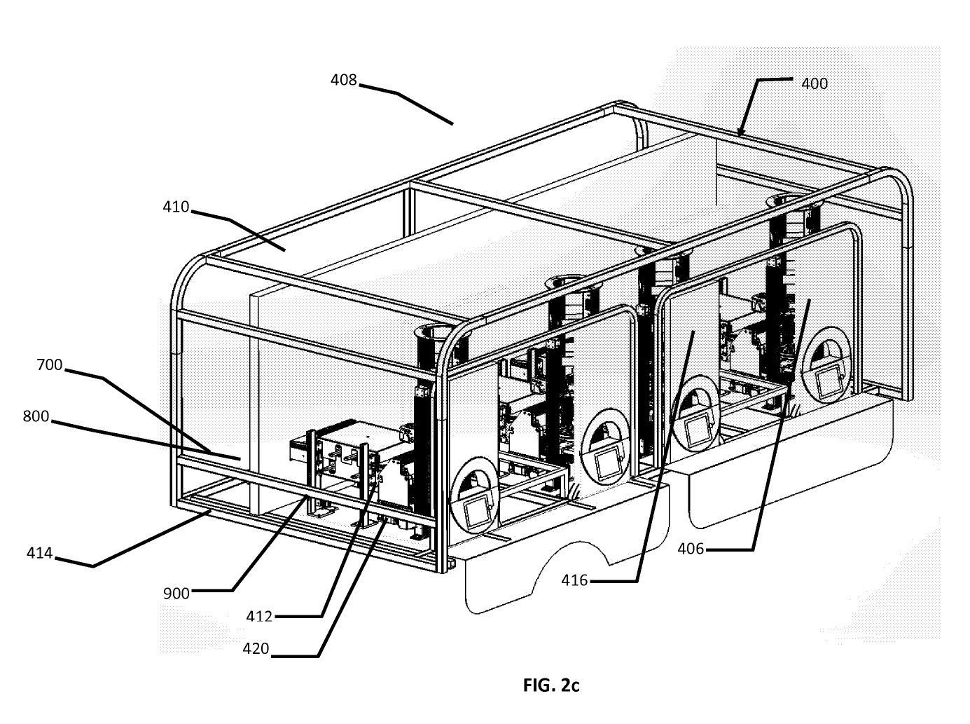

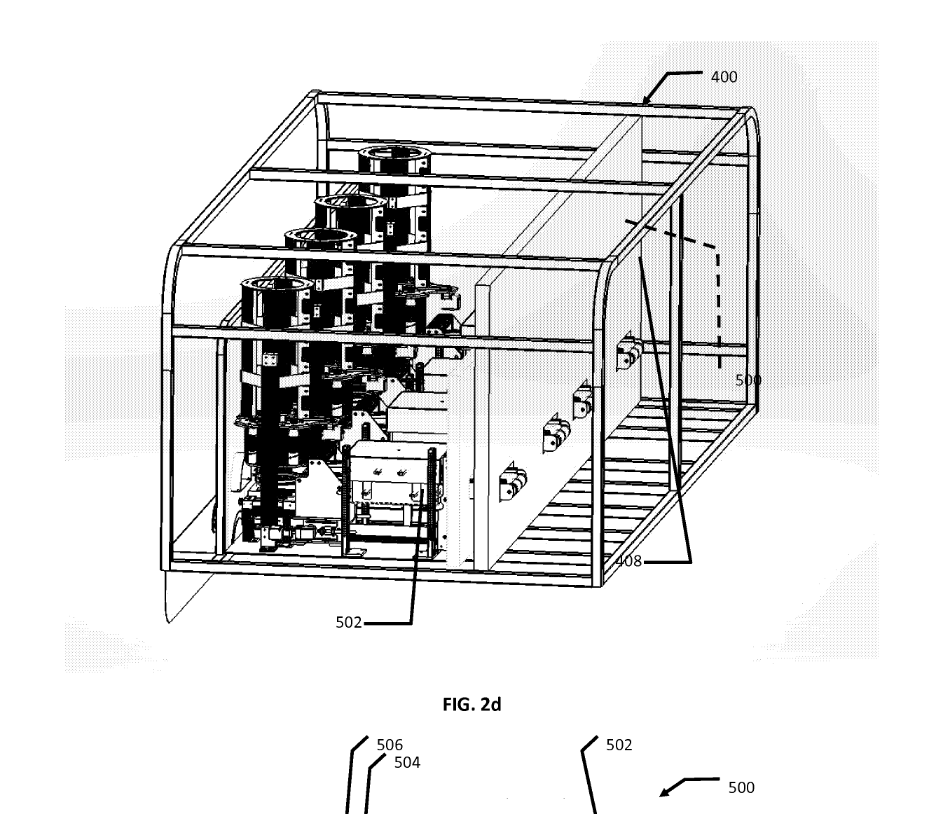

FIGS. 2a, 2b, 2c and 2d are schematic diagrams of a transportable vending system 400. Chassis 402 can include a battery storage compartment 404, a vending system compartment 406, a storage compartment 408 and a partition wall 410 separating food compartment 408 from vending system compartment. As seen in FIG. 2b, a plurality of food preparation and dispensation systems 450a, 450b, 450c and 450d can be disposed in vending system compartment 406. As seen in FIG. 2d an input end 502 of a conveyer can be disposed in food storage compartment 408.

As seen in FIG. 2c partitioning wall 410 between the high speed ovens and the pizzas or food item can insulate the food items till they need to be cooked. A sidewall of vending system 400 can include a dispensation opening 412. A door, flag, separator (not shown) or the like can be disposed at the dispensation opening 412, for example, to keep contaminants out of the oven/mobile device, and to keep the heat inside. In some embodiments, a user interface 420 can be provided. The user interface can include a touch screen, and the like. Chassis 402 can provide empty spaces 416 one or more of the food preparation and dispensation systems 450a, 450b, 450c and 450d. Empty spaces 416 can be utilized to provide a fountain dispensation system.

Chassis 402 can include a mounting plate 414 (FIG. 2c) to which is mounted one or more of the following:

a belt system 700 to convey food through a high speed oven;

a high speed oven 800;

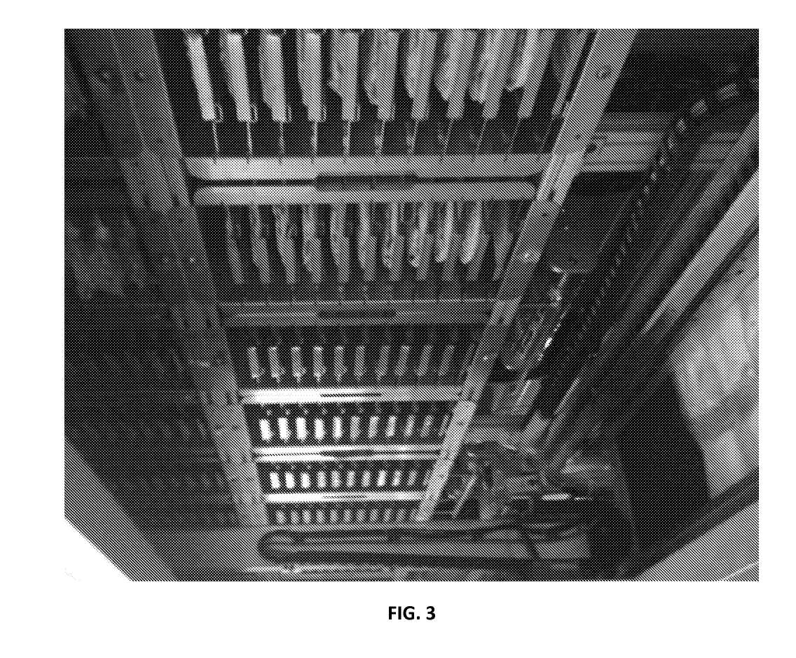

a storage container system (500 as seen in FIG. 3) to hold food items;

a plate dispensing system 900;

a carbonation system (not shown);

a water container (not shown);

a plate handling system 1000 (see FIG. 8);

a food conveyance system or gantry (502 in FIG. 3);

a motor control system (not shown);

a Programmable Logic Controller (PLC) (not shown);

touch screens;

credit card processing (not shown);

Wi-Fi connectivity (not shown);

a fire suppression system (not shown);

a batteries (not shown);

an inverter (not shown);

high current switches (not shown);

charging terminals (not shown);

wheels;

a truck chassis;

an operator interface (not shown);

a chilling or refrigeration system and associated controls (not shown);

a protective door on one or both sides of the conveyor (not shown);

and bank of stored food items

In some embodiments, the vertical exit of the conveyor is at a similar height of the beverage dispensing system.

In some embodiments, the batteries for use with a high speed stored energy oven are under the truck frame.

In some embodiments, the plate handling system is located on one side of the conveyor.

In some embodiments, the customer ordering user interface is located below the oven exit.

In some embodiments, the plate handling oven exit also actuates the opening of a door.

In some embodiments, the energy of the heating is controlled.

In some embodiments, the selection of the appropriate batteries is controlled for each oven in use.

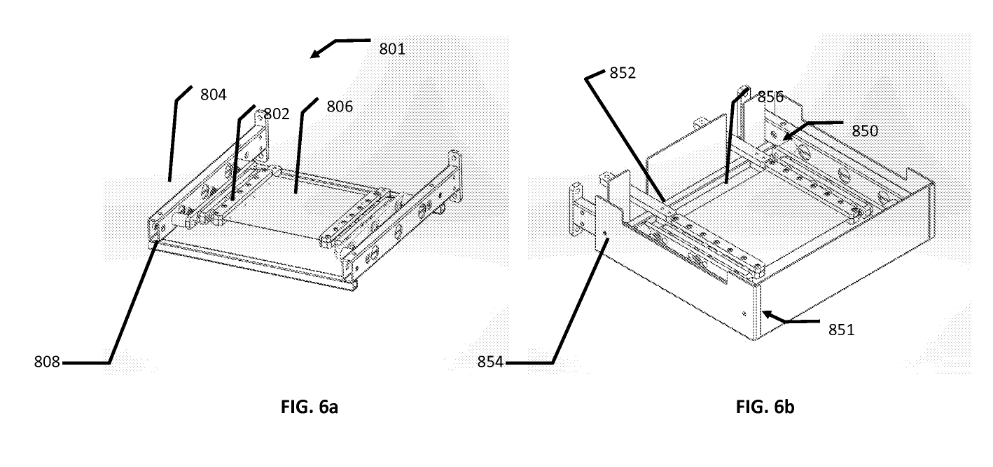

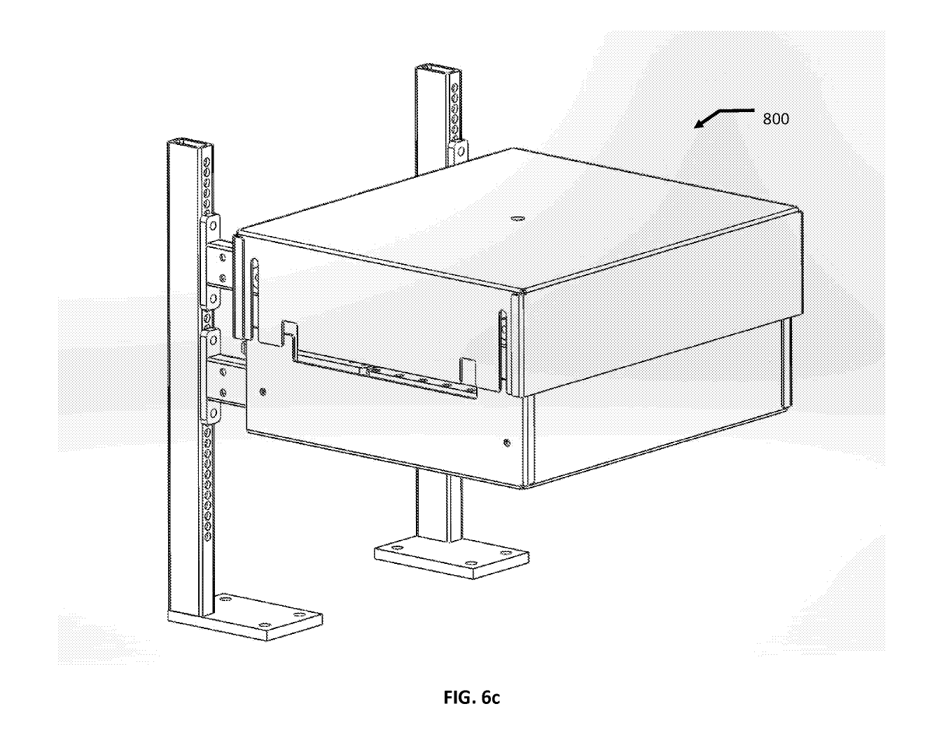

FIG. 3 is an embodiment of a food storage container 500. A gantry 502 can convey a selected food item 504 disposed in a food item bin 506 to an input (not visible in FIG. 6) of a food conveyance system. Food storage container 500 can be divided into banks

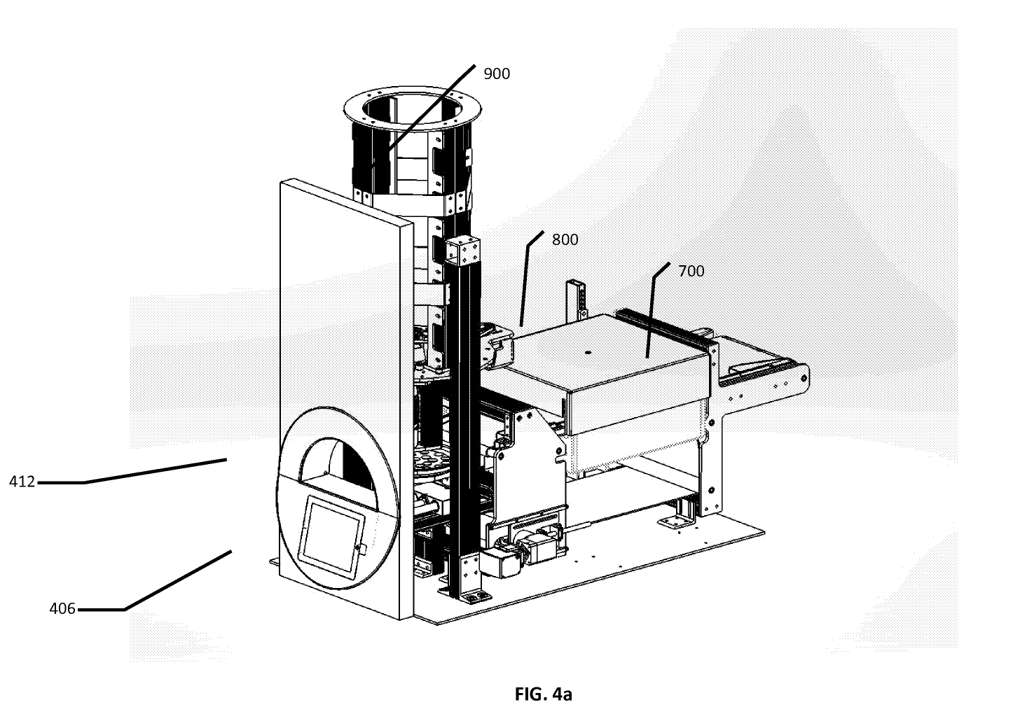

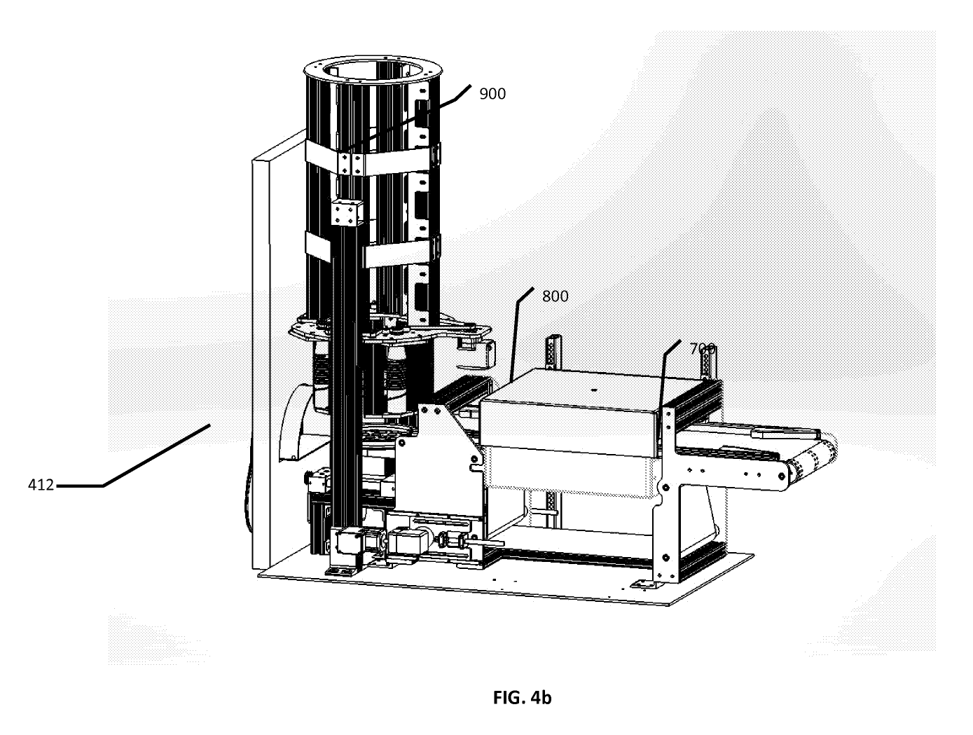

FIGS. 4a and 4b are schematic diagrams of a portion of a transportable vending system 600.

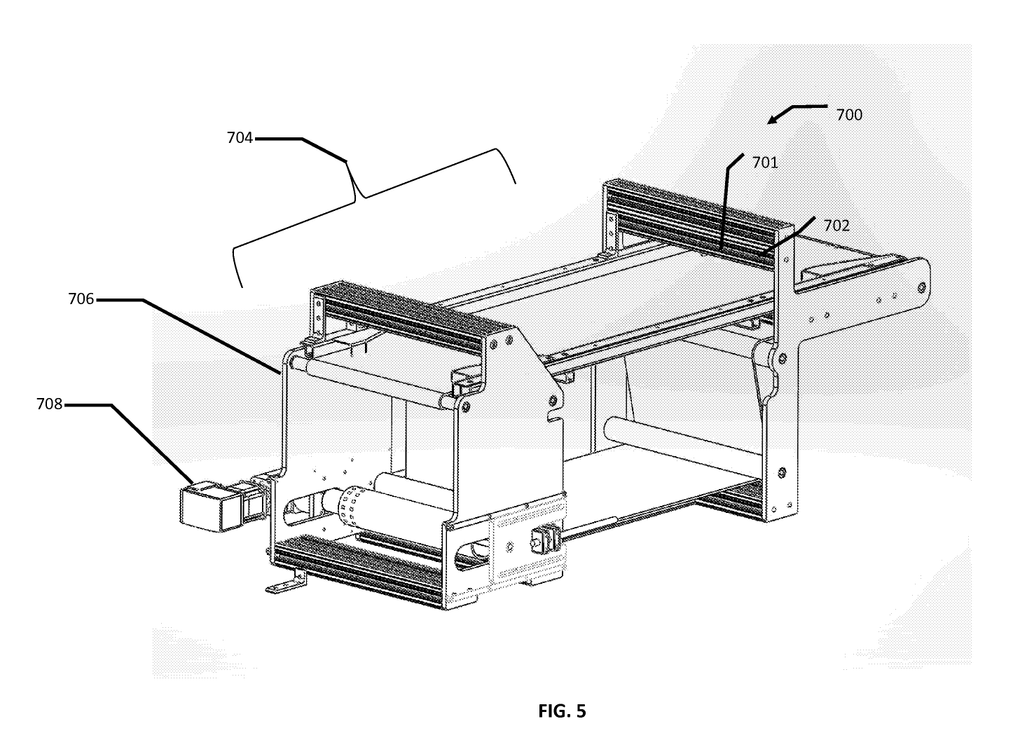

FIG. 5 is a schematic diagram of food item conveyer. Food items can be disposed by, for example, a gantry to the input end 702 of a belt 701. Food items can be transferred by belt 701 to an output end 706. In some embodiments, a plate handling system can be disposed at output end 706. Output end 706 can be disposed slightly higher than a plate disposed in the plate handle system. As such, when a food item drops off the output end 706 of belt 701, the food item drops into the plate. The plate handling system can convey the plate with the food item thereupon to a consumer/customer.

FIG. 6a is a schematic diagram of an upper housing 801 of a high speed stored energy oven. Heating element 802 can include a wire mesh. Bus bars 804 and 806 can energize the heating element 802. A highly reflective coating 808 can be disposed on an inside face of upper housing 801. For example, the reflective coating 808 can include a gold coating.

FIG. 6b is a schematic diagram of a lower housing 851 of a high speed stored energy oven. Heating element 852 can include a wire mesh. Bus bars 854 and 856 can energize the heating element 852. A highly reflective coating 858 can be disposed on an inside face of upper housing 851. For example, the reflective coating 858 can include a gold coating.

FIG. 6c is a schematic diagram of a high speed stored energy oven 800. In some embodiments, one or more of the upper or lower housings can be movable.

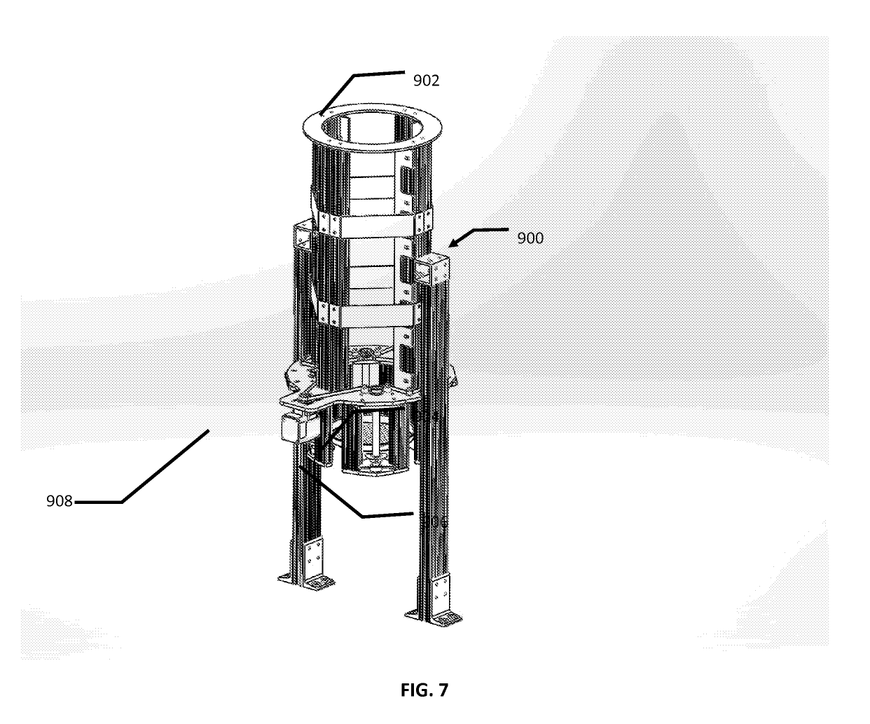

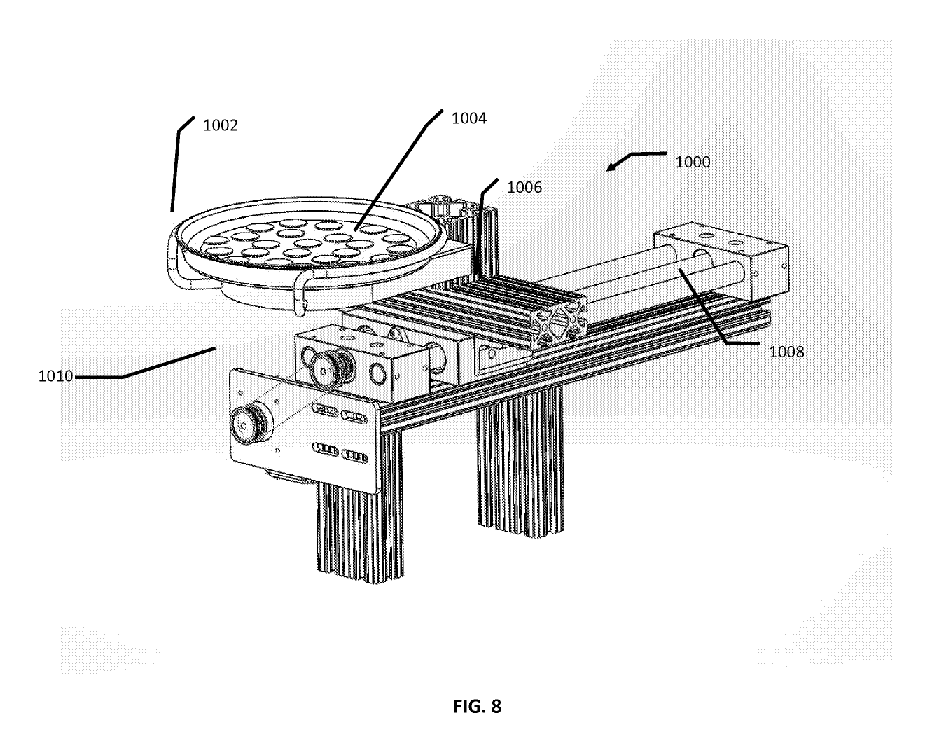

FIG. 7 is a schematic of a plate dispensing system 900. A plate 904 can be disposed in plate dispensing system 900 from an input opening 902. Plate 904 can be gravity fed onto a plate handling system from an output opening 906. A controller 908 can dispense plate 904 one at a time.

FIG. 8 is a schematic of a plate handling system 1000. A plate 1002 can be disposed into a plate catcher 1004. Plate 1002 can be disposed by, for example, plate dispensing system 900. Plate catcher 1004 can be moved between an oven end 1008 and a consumer delivery end on a slide 1006 under automation control.

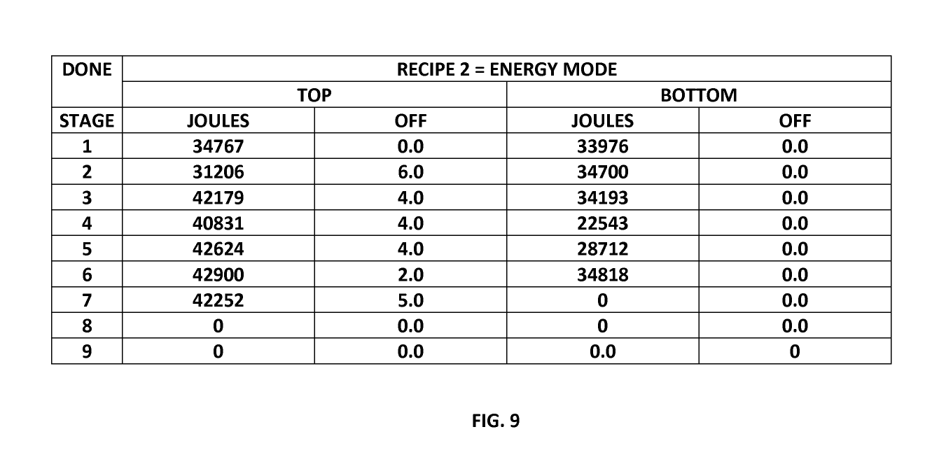

FIG. 9 is a table of energies consumed by a high speed stored energy oven during a cooking cycle. It also illustrates an item's oven profile. For example, when an item to be heated can scorch in the presence of a constant heat source, the heating element can be cycled on and off. For some items, like pizza, the bottom of the item needs to cook longer than a top of the item. As such, the top heating element profile can cycle on and off the top heating elements as desired. In exemplary embodiments, these energies are delivered to and consumed by the high speed stored energy oven in less than a minute. In some embodiments, these energies are delivered to and consumed by the high speed stored energy oven in less than two minutes. The heat

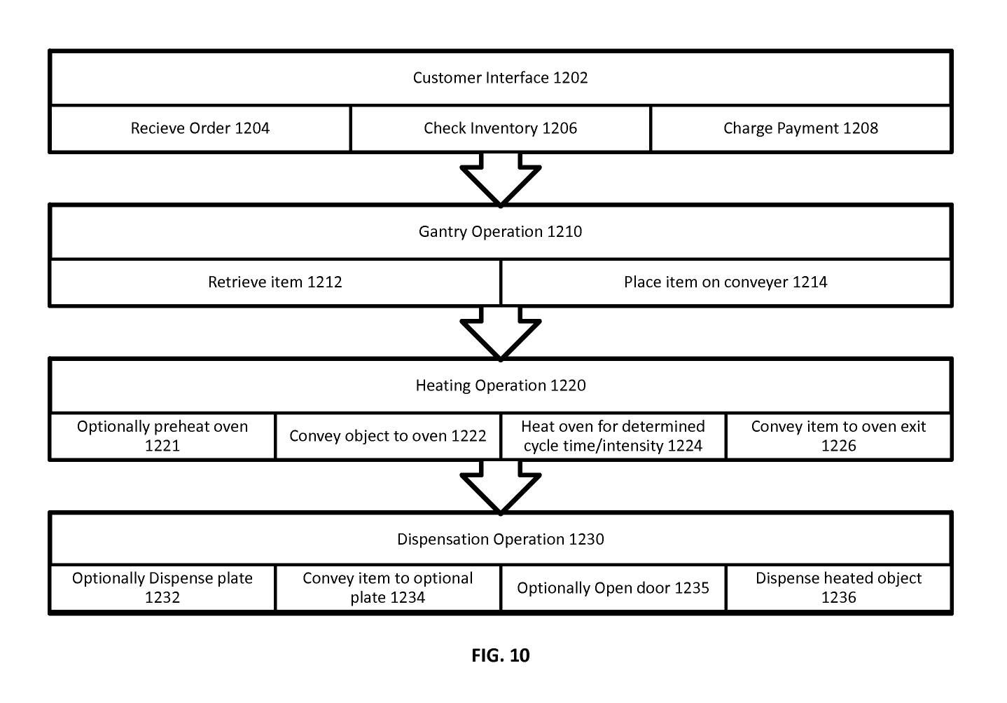

FIG. 10 is a process flow diagram for dispensing a food item. The logic disclosed in process flow 1200 can be programmed into a PLC or processor. A customer interface 1202 can receive order 1204. The process Checks Inventory 1206. The process can Charge Payment 1208 for the item or heat cycle. The Gantry Operation 1210 can retrieve item 1212 and place item on conveyer 1214. The Heating operation 1220 can optionally preheat oven 1221, convey item to oven 1222, heat oven for determined cycle times and intensity 1224, and convey item to oven exit 1226. The dispensation operation 1230 can optionally dispense a receptacle or plate 1232. The system can convey object to optional plate 1234 and optionally Open door 1235. The system can dispense heated object 1236.

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

1-25. (canceled)

26. A system for heating a product, the system comprising:
an oven comprising a heating element and configured to reach 1400 Kelvin in less than about 30 seconds, wherein the heating element is shaped to include a surface radiating heat;
a power supply comprising a stored energy device which is configured to provide a current to energize the heating element;
a conveyer configured to convey the product to a heating position facing the surface radiating heat; and
an electronic control and communication system configured to set an operational profile to control an operation of the heating element, wherein the operational profile includes a plurality of stages, each stage including a cycle time and a pulsation width of the heating element's on and off cycle.

27. The system of claim 26, wherein a sum of the cycle times of the plurality of stages for heating the product is less than two (2) minutes.

28. The system of claim 26, wherein the operation profile is set by receiving information detailing the product to be heated.

29. The system of claim 26, wherein the operational profile controls operations of the conveyer by setting a speed profile of the conveyer.

30. The system of claim 26, wherein the operational profile controls the heating element by setting one or more of a running voltage, a cycle profile, a distance of the surface from the product, and a fan speed.

31. The system of claim 26, wherein the heating element comprises a wire mesh or a perforated sheet.

32. The system of claim 26, wherein the heating element comprises heating elements that are disposed along multiple surfaces, each of the multiple surfaces radiating heat to the product as the product is conveyed by the conveyer, and
wherein the operational profile comprises multiple operational profiles, each corresponding to a respective heating element.

33. The system of claim 26, wherein the product is conveyed vertically along the surface radiating heat.

34. The system of claim 26, further comprising a gantry configured to dispense the product to an input end of the conveyer.

35. The system of claim 26, further comprising a storage system configured to store the product at a temperature less than 283° Kelvin (about 50° Fahrenheit), and wherein the product comprises a food item.

36. The system of claim 35, further comprising a gantry configured to transfer the food item from the storage system to an input end of the conveyer.

37. The system of claim 35, wherein the storage system is equipped with a sensor to detect the type of food placed into or removed from the storage system, and the electronic control and communication system is further configured to receive the food type from the sensor and configured to operate the heating elements and the conveyer using an operational profile associated with the food type.

38. The system of claim 35, further comprising a dispenser to dispense a receptacle to dispose the heated product therein, wherein the dispenser is disposed at an output end of the conveyer.

39. The system of claim 35, further comprising a user interface configured to receive a food item order, to receive a payment for the food item, and to initiate a cooked food item delivery.

40. The system of claim 35, further comprising a beverage dispensing system disposed in the chassis.

41. The system of claim 35, wherein the heating element is configured to cook the food item in less than a minute.

42. The system of claim 35, wherein the electronic control and communication system is configured to receive a food selection indication and a payment indication, to operate the heating elements and the conveyer using a profile associated with the food type, and to dispense the heated food item.

43. The system of claim 35, further comprising a separator configured to be disposed on the input end, the output end, or both ends of the oven.

44. The system of claim 35, further comprising a mobility device configured to change a location of the system.

45. The system of claim 35, further comprising a dispenser to dispose the heated product in a receptacle, wherein the dispenser is disposed at an output end of the conveyer.

46. The system of claim 26, wherein the oven is located above or partially above the stored energy device.

47. The system of claim 26, further comprising a filtration system configured to filter an exhaust generated by the oven.

48. The system of claim 26, wherein a distance of an outer surface of the product is less than six inches from the surface radiating heat.

49. The system of claim 26, wherein the oven comprises a plurality of ovens disposed in the chassis.
